(19) United States
(12) Patent Application Publication
(10) Pub. No.: US 2006/0207109 A1
(43) Pub. Date: Sep. 21, 2006

(54) Edged tool with handle

(75) Inventor: Akimune Numata, Seki-shi (JP)

Correspondence Address: POSZ LAW GROUP, PLC, 12040 SOUTH LAKES DRIVE, SUITE 101, RESTON, VA, 20191, US

(73) Assignee: KAI R&D CENTER CO., LTD., Gifu-ken (JP)

(21) Appl. No.: 11/373,958

(22) Filed: Mar. 14, 2006

(30) Foreign Application Priority Data
Mar. 15, 2005 (JP) 2005-073081

(51) Int. Cl. B25G 3/00

(52) U.S. Cl. 30/342

(57) ABSTRACT

Finger rest surfaces are formed on side surfaces of a bolster, which side surfaces are adjacent to side surfaces of a tang. The finger rest surfaces extend toward an edge of the tang from base lines, which are apart from a boundary between side surfaces of the blade plate and the side surfaces of the tang by a range of 10 mm or less toward the side surfaces of the tang. The finger rest surfaces are inclined to gradually separate from the side surfaces of the tang while extending away from boundary edge portions with respect to the side surfaces of the tang toward the edge of the tang. Finger rest surfaces are formed on the side surfaces of the bolster, which side surfaces are adjacent to the side surfaces of the blade plate. The finger rest surfaces extend toward the tang from the boundary between the side surfaces of the blade plate and the side surfaces of the tang or from the base lines, which are separate from the boundary toward the side surfaces of the blade plate. The finger rest surfaces are inclined to gradually separate from the side surfaces of the blade plate and the tang while extending away from the boundary edge portions with respect to the side surfaces of the blade plate toward the tang.

### BACKGROUND OF THE INVENTION

The present invention relates to an edged tool with handle such as a kitchen knife having a handle provided with a bolster to which a tang of a blade is inserted.

Such an edged tool with handle has been disclosed in Japanese Laid-Open Patent Publication No. 5-212162. In this publication, a blade plate 61 of a blade has a knife point (not shown) at the distal end and a proximal end, which is opposite to the knife point. As shown in FIG. 19, a tang 62, which extends from the proximal end of the blade plate 61, is inserted in a bolster 63 of the handle. A cutting edge 65 extends along the belly of the blade plate 61 from the knife point to a heel 64 located at the proximal end of the blade plate 61. A return 66 is connected to the cutting edge 65 and extends from the heel 64 of the blade plate 61 to a boundary 71 between the blade plate 61 and the tang 62. A spine 69 of the tang 62 is connected to a spine 68, which extends, at the back of the blade plate 61, from the knife point to the boundary 71 between the blade plate 61 and the tang 62. Both sides of the tang 62 are exposed at sections between a belly edge 67, which forms a step on the belly of the tang 62 and the spine 69 of the tang 62.

When a user performs a delicate manual work such as peeling with a kitchen knife, the user places the palm of the right hand on the back of the bolster and a grip portion as needed. Also, the user holds the heel with a thumb and a forefinger of the right hand while placing the thumb and the forefinger on the end faces of the bolster, and places a middle finger, a third finger, and a little finger on the belly of the bolster and the grip portion. The user grips the kitchen knife by arranging the fingers as described above.

However, if the length of the side surfaces of the tang 62 that are exposed from an end portion 70 of the bolster 63 is too long, or if the end portion 70 of the bolster 63 is angulated, it is difficult to grip the kitchen knife when holding the heel 64 with the thumb and the forefinger.

### SUMMARY OF THE INVENTION

Accordingly, it is an objective of the present invention to allow a user to easily hold an edged tool with handle such as a kitchen knife with fingers placed as described above.

To achieve the foregoing objective and in accordance with a first aspect of the present invention, an edged tool with handle comprising a blade including a blade plate and a tang, which extends from the proximal end of the blade plate located opposite to a knife point at the distal end of the blade plate, and a handle having a bolster in which the tang is inserted, is provided. The blade includes a cutting edge, a return, a belly edge. The cutting edge extends along the belly of the blade plate from the knife point to a heel located at the proximal end of the blade plate. The return intersects the cutting edge at the heel of the blade plate and is connected to a boundary between the blade plate and the tang located at the proximal end of the blade plate. The belly edge is connected to the return on the belly of the tang to form a step. The blade also includes a spine that extends along the back of the blade plate from the knife point to the boundary between the blade plate and the tang, and a spine that is connected to the spine of the blade plate on the back of the tang. The blade further includes an edge of the tang located between the belly edge and the spine, side surfaces of the blade plate, and a side surfaces of the tang. The side surfaces of the blade plate are surrounded by the cutting edge, the return, the spine, and the boundary. The side surfaces of the tang are surrounded by the boundary, the belly edge, the spine, and the edge. Finger rest surfaces are formed on side surfaces of the bolster, which side surfaces are adjacent to the side surfaces of the blade plate. The finger rest surfaces extend toward the tang from the boundary between the side surfaces of the blade plate and the side surfaces of the tang or from base lines, which are apart from the boundary toward the side surfaces of the blade plate. The finger rest surfaces are inclined to gradually separate from the side surfaces of the blade plate and the tang while extending away from boundary edge portions with respect to the side surfaces of the blade plate toward the tang.

In accordance with a second aspect of the present invention, an edged tool with handle comprising a blade including a blade plate and a tang, which extends from the proximal end of the blade plate located opposite to a knife point at the distal end of the blade plate, and a handle having a bolster in which the tang is inserted, is provided. The blade includes a cutting edge, a return, a belly edge. The cutting edge extends along the belly of the blade plate from the knife point to a heel located at the proximal end of the blade plate. The return intersects the cutting edge at the heel of the blade plate and is connected to a boundary between the blade plate and the tang located at the proximal end of the blade plate. The belly edge is connected to the return on the belly of the tang to form a step. The blade also includes a spine that extends along the back of the blade plate from the knife point to the boundary between the blade plate and the tang, and a spine that is connected to the spine of the blade plate on the back of the tang. The blade further includes an edge of the tang located between the belly edge and the spine, side surfaces of the blade plate, and a side surfaces of the tang. The side surfaces of the blade plate are surrounded by the cutting edge, the return, the spine, and the boundary. The side surfaces of the tang are surrounded by the boundary, the belly edge, the spine, and the edge. Finger rest surfaces are formed on side surfaces of the bolster, which side surfaces are adjacent to the side surfaces of the tang. The finger rest surfaces extend toward the edge of the tang from base lines, which are apart from the boundary between the side surfaces of the blade plate and the side surfaces of the tang toward the side surfaces of the tang by a range of 10 mm or less. The finger rest surfaces are inclined to gradually separate from the side surfaces of the tang while extending away from boundary edge portions with respect to the side surfaces of the tang toward the edge of the tang.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a front view illustrating an edged tool with handle according to a first embodiment where a blade and a bolster are separated during a manufacturing process;

FIG. 1(b) is a perspective view illustrating the bolster of FIG. 1(a);

FIG. 2 is a front view illustrating a state where the tang of the blade shown in FIG. 1(a) is inserted in the bolster;

FIG. 3(a) is a front view illustrating a coupled state where the tang of the blade shown in FIG. 2 and the bolster are welded to each other;

FIG. 3(b) is a partial cross-sectional plan view illustrating the coupling portion between the tang and the bolster shown in FIG. 3(a);

FIG. 4 is a front view illustrating a state where the welded portion is scraped off from the coupling portion between the tang and the bolster shown in FIG. 3(a);

FIG. 5 is a front view illustrating a state where the coupling portion between the tang and the bolster shown in FIG. 4 is ground and polished;

FIG. 6(a) is a front view illustrating an edged tool equipped with a handle formed by coupling a grip portion to the bolster shown in FIG. 5;

FIG. 6(b) is a back view illustrating the edged tool of FIG. 6(a);

FIG. 6(c) is a right side view illustrating the edged tool of FIG. 6(a);

FIG. 6(d) is a left side view illustrating the edged tool of FIG. 6(a);

FIG. 7(a) is a partial front view illustrating the coupling portion between the tang and the bolster of the edged tool shown in FIG. 6(a);

FIG. 7(b) is a partial plan view illustrating the coupling portion of FIG. 7(a);

FIG. 7(c) is a partial back view illustrating the coupling portion of FIG. 7(a);

FIG. 8(a) is a partial front view illustrating the coupling portion between a tang and a bolster of an edged tool according to a modified embodiment of the first embodiment;

FIG. 8(b) is a partial plan view illustrating the coupling portion of FIG. 8(a);

FIG. 8(c) is a partial back view illustrating the coupling portion of FIG. 8(a);

FIG. 9(a) is a partial front view illustrating a coupling portion between a tang and a bolster of an edged tool according to a second embodiment;

FIG. 9(b) is a partial plan view illustrating the coupling portion of FIG. 9(a);

FIG. 9(c) is a partial back view illustrating the coupling portion of FIG. 9(a);

FIG. 10(a) is a partial front view illustrating a coupling portion between a tang and a bolster of an edged tool according to a third embodiment;

FIG. 10(b) is a partial plan view illustrating the coupling portion of FIG. 10(a);

FIG. 10(c) is a partial back view illustrating the coupling portion of FIG. 10(a);

FIG. 11(a) is a partial front view illustrating a coupling portion between a tang and a bolster of an edged tool according to a fourth embodiment;

FIG. 11(b) is a partial plan view illustrating the coupling portion of FIG. 11(a);

FIG. 11(c) is a partial back view illustrating the coupling portion of FIG. 11(a);

FIG. 12(a) is a partial front view illustrating a coupling portion between a tang and a bolster of an edged tool according to a fifth embodiment;

FIG. 12(b) is a partial plan view illustrating the coupling portion of FIG. 12(a);

FIG. 12(c) is a partial back view illustrating the coupling portion of FIG. 12(a);

FIG. 13(a) is a partial front view illustrating a coupling portion between a tang and a bolster of an edged tool according to a sixth embodiment;

FIG. 13(b) is a partial plan view illustrating the coupling portion of FIG. 13(a);

FIG. 13(c) is a partial back view illustrating the coupling portion of FIG. 13(a);

FIG. 14(a) is a partial front view illustrating a coupling portion between a tang and a bolster of an edged tool according to a seventh embodiment;

FIG. 14(b) is a partial plan view illustrating the coupling portion of FIG. 14(a);

FIG. 14(c) is a partial back view illustrating the coupling portion of FIG. 14(a);

FIG. 15(a) is a partial front view illustrating a coupling portion between a tang and a bolster of an edged tool according to an eighth embodiment;

FIG. 15(b) is a partial plan view illustrating the coupling portion of FIG. 15(a);

FIG. 15(c) is a partial back view illustrating the coupling portion of FIG. 15(a);

FIG. 16(a) is a partial front view illustrating a coupling portion between a tang and a bolster of an edged tool according to a ninth embodiment;

FIG. 16(b) is a partial plan view illustrating the coupling portion of FIG. 16(a);

FIG. 16(c) is a partial back view illustrating the coupling portion of FIG. 16(a);

FIG. 17(a) is a front view illustrating a state where a back member for hone is attached to an edged tool according to a tenth embodiment;

FIG. 17(b) is an explanatory diagram illustrating a state where the edged tool of FIG. 17(a) is ground with a hone;

FIG. 18(a) is a front view illustrating an edged tool with a case according to an eleventh embodiment;

FIG. 18(b) is a partial cross-sectional plan view illustrating the edged tool of FIG. 18(a); and

FIG. 19 is a partial cross-sectional view illustrating a prior art edged tool.

### DETAILED DESCRIPTION OF THE PREFERRED EMBODIMENTS

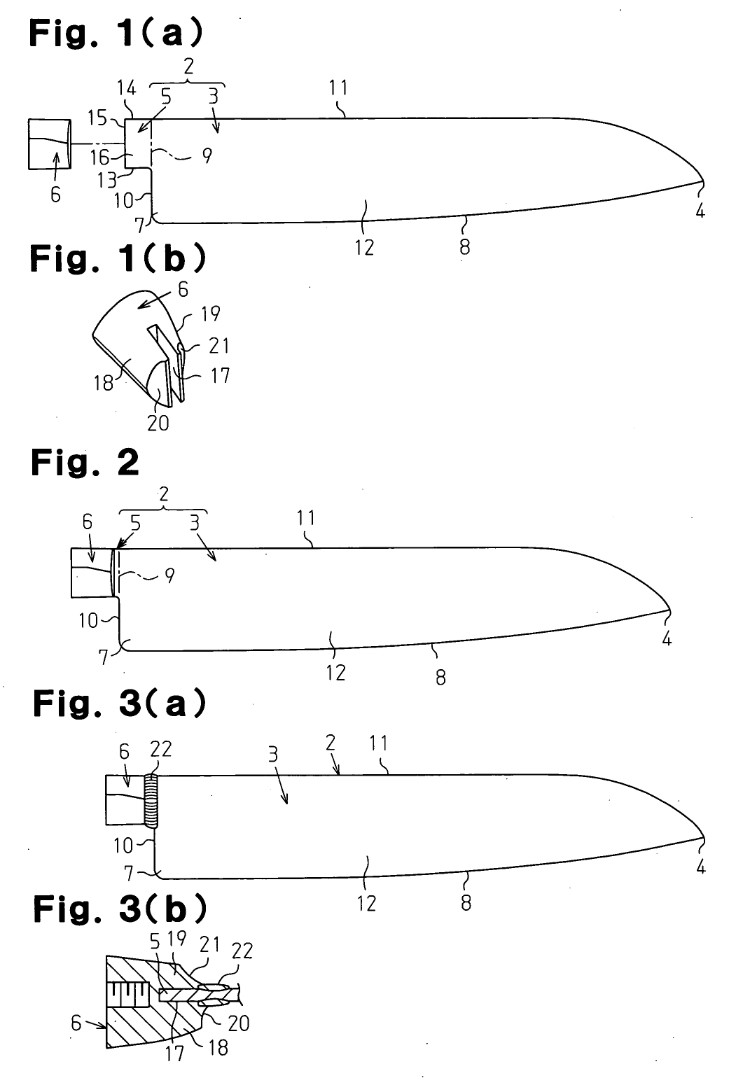

An edged tool 1 according to a first embodiment of the present invention will now be described with reference to FIGS. 1(a) to 7(c).

A procedure for manufacturing the edged tool 1, that is, a kitchen knife shown in FIGS. 6(a) to 6(d) will be briefly explained.

First, a blade material is cut out from a base material, and the blade material is machined to form a blade 2 shown in FIG. 1(a). The blade 2 includes a tang 5 and a blade plate 3, which is formed of three layers of steel. The tang 5 extends from the proximal end of the blade plate 3 located opposite to a knife point 4 located at the distal end of the blade plate 3. Also, as shown in FIG. 1(a), a bolster 6 to which the tang 5 is to be inserted is molded. The bolster 6 is formed of stainless-steel (SUS430). To prevent the tang 5 from being loosely fitted to the bolster 6, the thickness of the tang 5 is unchanged from that of the base material during machining of the blade material.

The blade plate 3 of the blade 2 includes, a cutting edge 8, which extends along the belly of the blade plate 3 from the knife point 4 to a heel 7 located at the proximal end of the blade plate 3, a return 10, which intersects the cutting edge 8 at the heel 7 of the blade plate 3 and is connected to a boundary 9 between the blade plate 3 and the tang 5 located at the proximal end of the blade plate 3, a spine 11, which extends along the back of the blade plate 3 from the knife point 4 to the boundary 9 between the blade plate 3 and the tang 5, and side surfaces 12, which are sections of the blade plate 3 surrounded by the cutting edge 8, the return 10, the spine 11, and the boundary 9 between the blade plate 3 and the tang 5.

The tang 5 of the blade 2 includes a belly edge 13, which is connected to the return 10 on the belly of the tang to form a step, a spine 14, which is connected to the spine 11 of the blade plate 3 on the back of the tang 5, en edge 15 located between the belly edge 13 and the spine 14, and side surfaces 16, which are surrounded by the boundary 9, the belly edge 13, the spine 14, and the edge 15.

As for the bolster 6, as shown in FIGS. 1(b) and 3(b), a tang insertion groove 17 is formed at the distal end of the bolster 6 extending toward the proximal end. The distal end of the bolster 6 is branched into arm portions 18, 19, which sandwich the tang insertion groove 17. Inclined portions 20, 21 are formed at the distal ends of the arm portions 18, 19, respectively.

Next, as shown in FIG. 2, the tang 5 of the blade 2 is inserted into the tang insertion groove 17 of the bolster 6.

Then, as shown in FIGS. 3(a) and 3(b), the distal ends of the inclined portions 20, 21 formed at the arm portions 18, 19 of the bolster 6 and a section where the tang 5 and the blade plate 3 are connected to each other are welded.

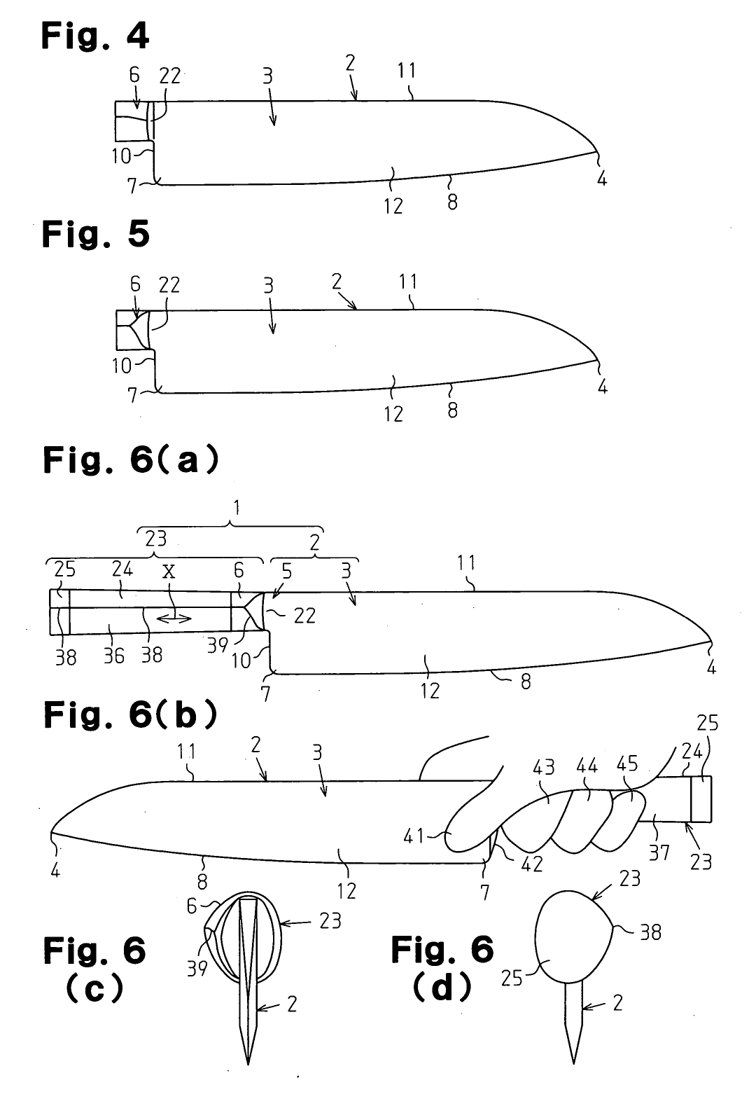

Then, as shown in FIG. 4, the outer surface of a coupling portion 22 between the tang 5 and the bolster 6 produced by welding is scraped off.

Then, as shown in FIG. 5, the coupling portion 22 between the tang 5 and the bolster 6 and the entire surface of the bolster 6 including the inclined portions 20, 21 of the arm portions 18, 19 are ground and polished. Thereafter, the exposed surface of the blade 2 is provided with a black coating of TICN (titanium carbonitride).

Then, as shown in FIG. 6(a), a handle 23 is attached to the blade 2. The handle 23 includes a grip portion 24, which is coupled to the bolster 6 located at the head portion and extends toward the butt portion. A butt cap 25 is coupled to the butt portion of the grip portion 24. The grip portion 24 is formed of a compressed laminated wood, and the butt cap 25 is formed of stainless-steel (SUS430). Thereafter, the cutting edge 8 of the blade 2 is sharpened. Furthermore, a laser is irradiated at the black coating surface of the blade 2 to inscribe a model number and a quality control number. The length of the bolster 6 along the longitudinal direction X connecting the head portion and the butt portion of the handle 23 is approximately 20 mm, and the length of the butt cap 25 is approximately 12 mm. The bolster 6 and the butt cap 25 increase the entire weight of the handle 23 to optimize the balance of the weight with respect to the blade 2.

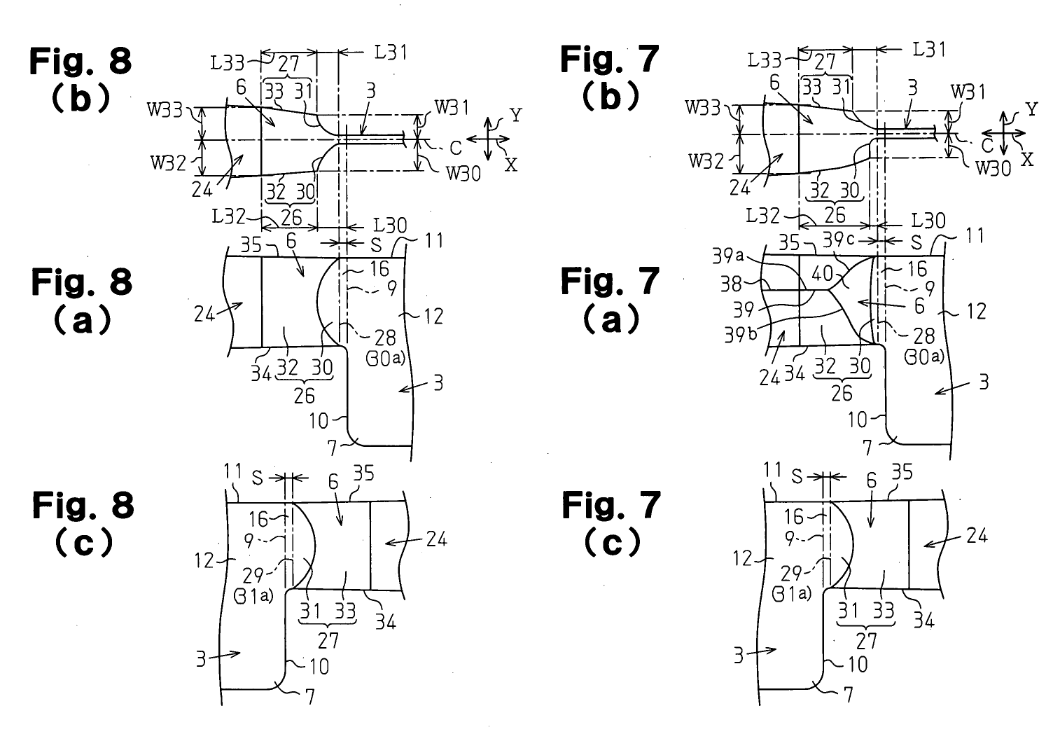

In the edged tool 1 manufactured as described above, as shown in FIGS. 7(a), 7(b), and 7(c), finger rest surfaces 30, 31 are formed on side surfaces 26, 27 of the bolster 6, which side surfaces 26, 27 are adjacent to the side surfaces 16 of the tang 5. The finger rest surfaces 30, 31 extend from base lines 28, 29 toward the edge 15 of the tang 5. The base lines 28, 29 are apart from the boundary 9 between the side surfaces 12 of the blade plate 3 and the side surfaces 16 of the tang 5 by a distance S toward the side surfaces 16 of the tang 5. The distance S is within a range of 10 mm or less, and is preferably set within a range of 0.5 mm or more and 6 mm or less, and more preferably within a range of 1 mm or more and 3 mm or less.

The finger rest surfaces 30, 31 incline to form concavities such that the finger rest surfaces 30, 31 gradually separate from the side surfaces 16 of the tang 5 while extending from boundary edge portions with respect to the side surfaces 16 of the tang 5 (boundary edges 30a, 31a on the base lines 28, 29) toward the edge 15 of the tang 5. The finger rest surfaces 30, 31 are connected to and flush with the side surfaces 16 of the tang 5 at the boundary edges 30a, 31a. Also, finger contact surfaces 32, 33 are formed on the side surfaces 26, 27 of the bolster 6. The finger contact surfaces 32, 33 are located between the finger rest surfaces 30, 31 and the grip portion 24 and are connected to the finger rest surfaces 30, 31. The finger contact surfaces 32, 33 are connected to each other via a belly surface 34 and a back surface 35 of the bolster 6, which extend between the spine 11 of the blade plate 3 and the grip portion 24.

As for the maximum dimensions L30, L31 of the finger rest surfaces 30, 31 of the side surfaces 26, 27 of the bolster 6 along the longitudinal direction X connecting the head portion and the butt portion of the handle 23, the maximum dimension L31 of the finger rest surface 31 of one of the side surfaces 26, 27 (the side surface 27) of the bolster 6 is greater than the maximum dimension L30 of the finger rest surface 30 of the other one of the side surfaces 26, 27 (the side surface 26).

As for the minimum dimensions L32, L33 of the finger contact surfaces 32, 33 of the side surfaces 26, 27 of the bolster 6 along the longitudinal direction X of the handle 23, the minimum dimension L33 of the finger contact surface 33 of one of the side surfaces 26, 27 (the side surface 27) of the bolster 6 is smaller than the minimum dimension L32 of the finger contact surface 32 of the other one of the side surfaces 26, 27 (the side surface 26).

Also, as for the maximum dimensions W30, W31, W32, and W33 of the finger rest surfaces 30, 31 and the finger contact surfaces 32, 33 of the side surfaces 26, 27 of the bolster 6 with respect to the center line C of the thickness direction Y of the blade plate 3, the maximum dimension W31 of the finger rest surface 31 of one of the side surfaces 26, 27 (the side surface 27) is smaller than the maximum dimension W30 of the finger rest surface 30 of the other one of the side surfaces 26, 27 (the side surface 26) while the maximum dimension W33 of the finger contact surface 33 of one of the side surfaces 26, 27 (the side surface 27) is smaller than the maximum dimension W32 of the finger contact surface 32 of the other one of the side surfaces 26, 27 (the side surface 26).

Furthermore, the maximum dimension W33 of the finger contact surface 33 of one of the side surfaces 26, 27 (the side surface 27) is greater than the maximum dimension W31 of the finger rest surface 31, while the maximum dimension W32 of the finger contact surface 32 of the other one of the side surfaces 26, 27 (the side surface 26) is greater than the maximum dimension W30 of the finger rest surface 30.

As shown in FIGS. 6(a) to 7(c), a ridge line 38 is formed on the grip portion 24 and the butt cap 25 of the handle 23. More specifically, the ridge line 38 is formed on one of side surfaces 36, 37 (the side surface 36 in this embodiment) adjacent to the finger contact surfaces 32, 33 of the bolster 6 and the butt cap 25 of the handle 23. The ridge line 38 extends along the longitudinal direction X of the handle 23 through the entire longitudinal direction X of the grip portion 24 and the butt cap 25. A ridge line 39, which is continuous with the ridge line 38 on the side surface 36 of the grip portion 24, is formed on the finger contact surface 32 of the bolster 6. The ridge line 39 on the finger contact surface 32 of the bolster 6 includes a first ridge line 39a, which extends along the longitudinal direction X of the handle 23 and is continuous with the ridge line 38 on the side surface 36 of the grip portion 24, and second ridge lines 39b, 39c, which branch from the first ridge line 39a toward the finger rest surface 30 of the bolster 6. A partition surface 40, which is inclined with respect to the center line C of the thickness direction Y of the blade plate 3, is formed on the finger contact surface 32 of the bolster 6 between the second ridge lines 39b, 39c and the finger rest surface 30. The ridge lines 38, 39 may be slightly rounded.

As shown in FIG. 6(b), when a user performs a delicate manual work such as peeling with the kitchen knife, the user places the palm of the right hand on the back of the bolster 6 and the grip portion 24 as needed. Then, the user holds the heel 7 with a thumb 41 and a forefinger 42 by placing the thumb 41 on the finger rest surface 31 of the bolster 6, the forefinger 42 on the finger rest surface 30 of the bolster 6, and a middle finger 43 on the partition surface 40 of the finger contact surface 32. Then, the user places the middle finger 43 on the belly of the bolster 6, and a third finger 44 and a little finger 45 on the belly of the grip portion 24. The user grips the edged tool 1 by arranging the fingers 41, 42, 43, 44, 45 as described above.

The edged tool 1 according to a modified embodiment of the first embodiment of the present invention shown in FIGS. 8(a) to 8(c) differs from that of the first embodiment (see FIGS. 7(a) to 7(c)) in that the ridge lines 38, 39 are not formed, the maximum dimension L31 of the finger rest surface 31 is equal to the maximum dimension L30 of the finger rest surface 30, and the minimum dimension L33 of the finger contact surfaces 33 is equal to the minimum dimension L32 of the finger contact surfaces 32.

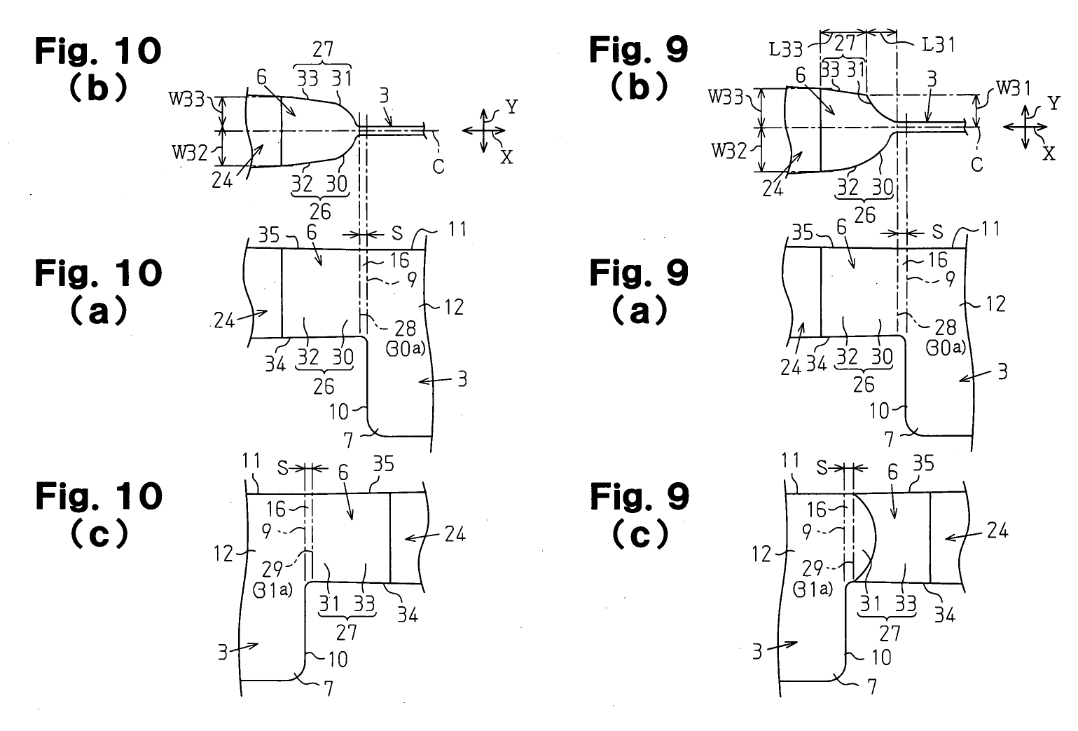

As shown in FIGS. 9(a) to 9(c), the edged tool 1 according to a second embodiment of present invention differs from that of the first embodiment (see FIGS. 7(a) to 7(c)) in that the ridge lines 38, 39 are not formed, the finger rest surface 31 of the bolster 6 is inclined to form a concavity, and the finger rest surface 30 is inclined to form a convexity.

As shown in FIGS. 10(a) to 10(c), the edged tool 1 according to a third embodiment of the present invention differs from that of the first embodiment (see FIGS. 7(a) to 7(c)) in that the ridge lines 38, 39 are not formed, and the finger rest surfaces 30, 31 of the bolster 6 are both inclined to form convexities.

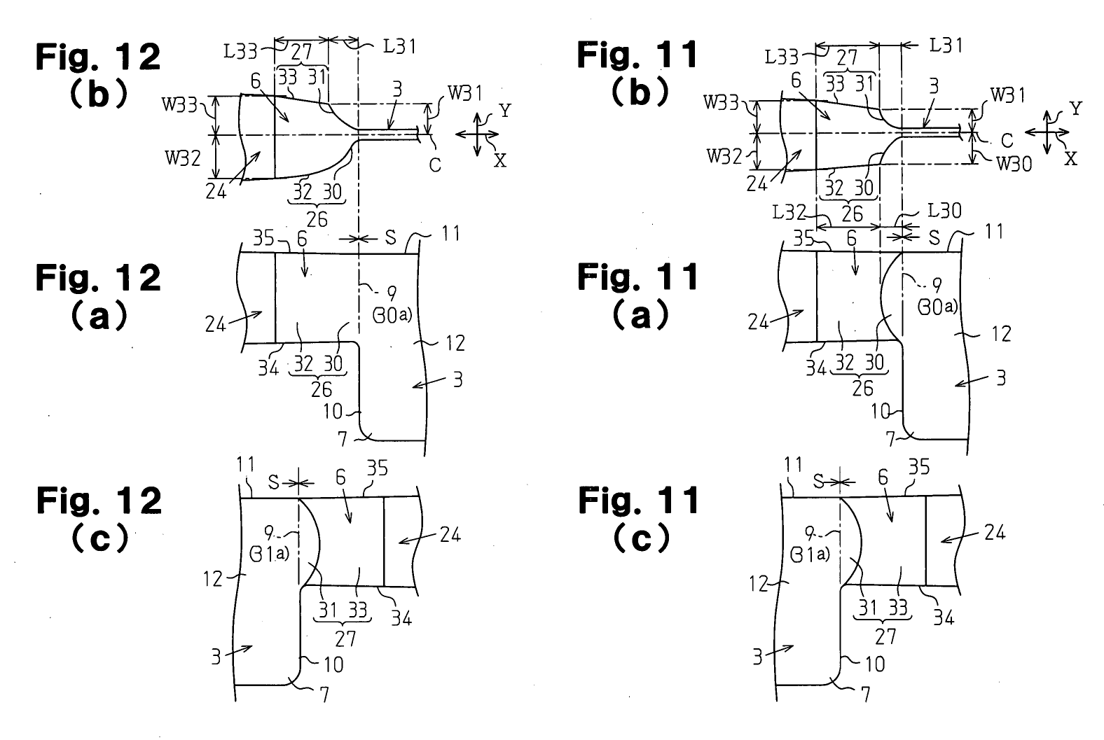

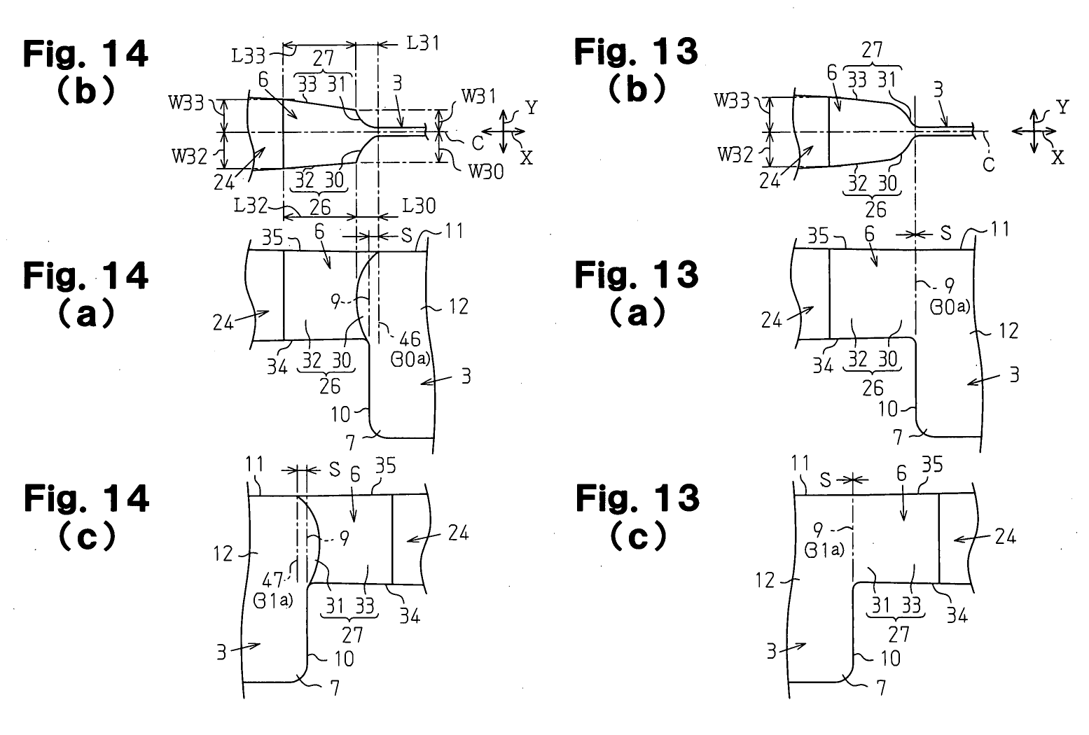

The edged tool 1 according to a fourth embodiment of the present invention shown in FIGS. 11(a) to 11(c) differs from that of the modified embodiment of the first embodiment (see FIGS. 8(a) to 8(c)), the edged tool 1 according to a fifth embodiment of the present invention shown in FIGS. 12(a) to 12(c) differs from that of the second embodiment (see FIGS. 9(a) to 9(c)), and the edged tool 1 according to a sixth embodiment of the present invention shown in FIGS. 13(a) to 13(c) differs from that of the third embodiment (see FIGS. 10(a) to 10(c)) in the following aspect.

The finger rest surfaces 30, 31 of the bolster 6 extend from the boundary 9 (distance S=0 mm) between the side surfaces 12 of the blade plate 3 and the side surfaces 16 of the tang 5 toward the tang 5, and are inclined to gradually separate from the side surfaces 12, 16 of the blade plate 3 and the tang 5 while extending away from the boundary edge portions (the boundary edges 30a, 31a on the boundary 9) with respect to the side surfaces 12 of the blade plate 3 toward the tang 5.

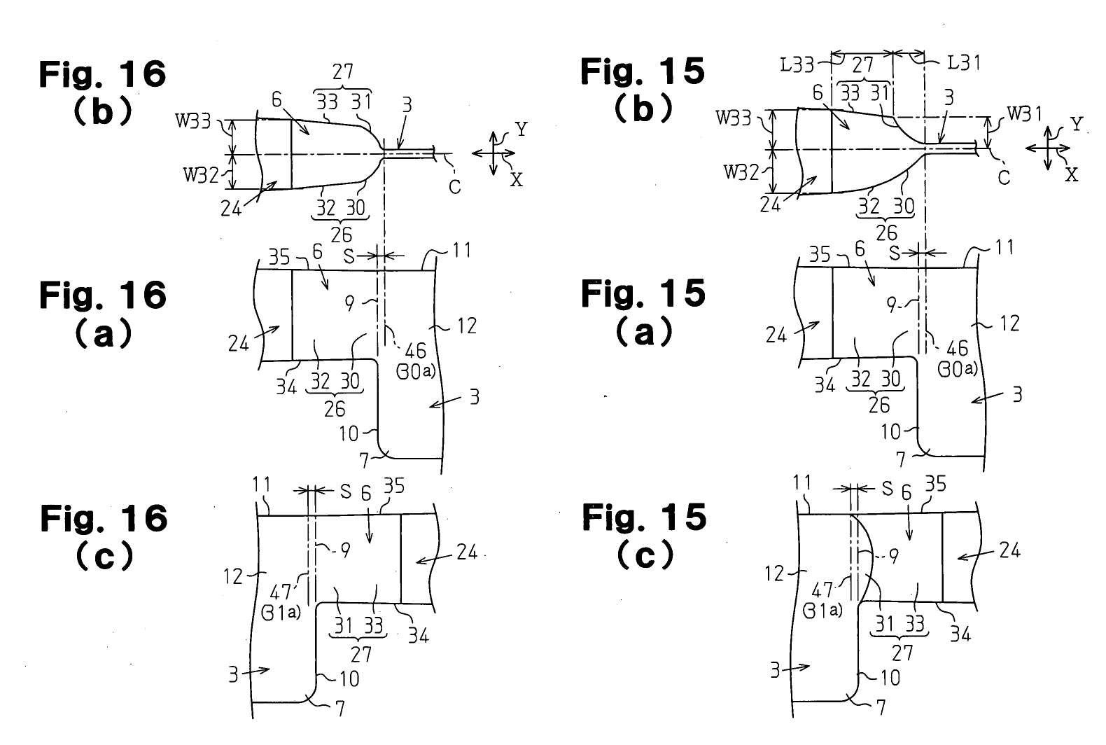

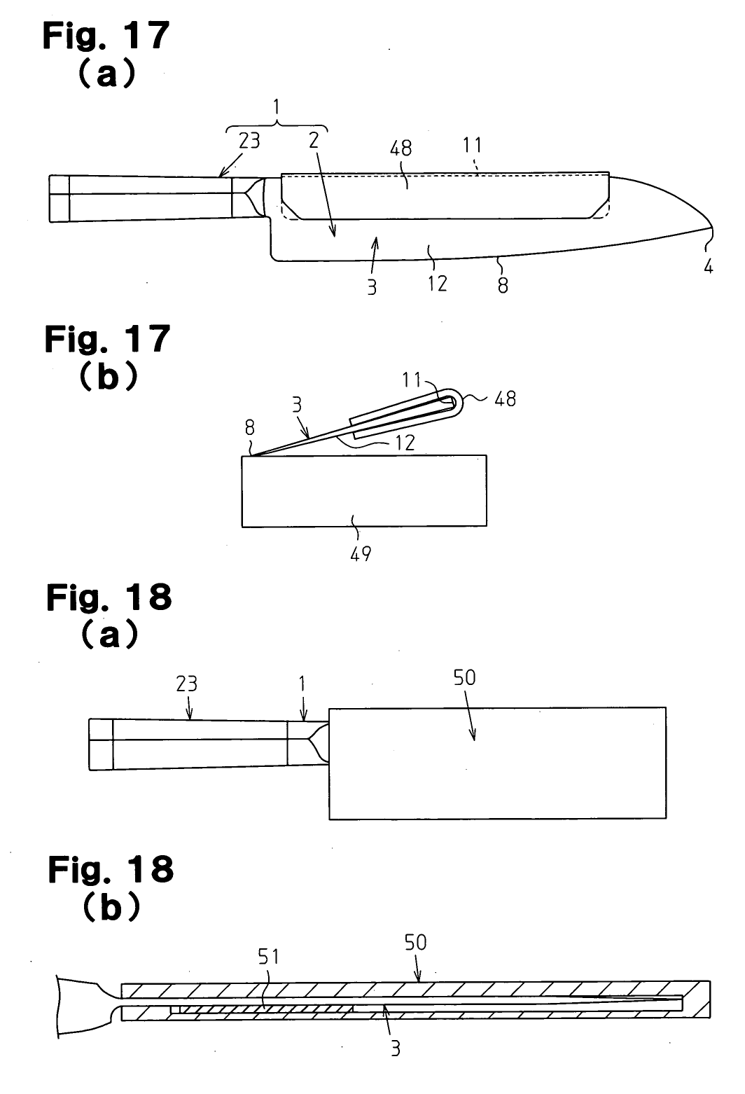

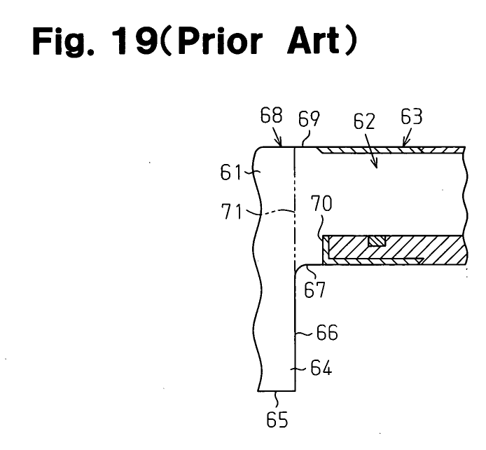

The edged tool 1 according to a seventh embodiment of the present invention shown in FIGS. 14(a) to 14(c) differs from that of the modified embodiment of the first embodiment (see FIGS. 8(a) to 8(c)), the edged tool 1 according to an eighth embodiment of the present invention shown in FIGS. 15(a) to 15(c) differs from that of the second embodiment (see FIGS. 9(a) to 9(c)), and the edged tool 1 according to a ninth embodiment of the present invention shown in FIGS. 16(a) to 16(c) differs from that of the third embodiment (see FIGS. 10(a) to 10(c)) in the following aspect.

The finger rest surfaces 30, 31 of the bolster 6 extend from ridge lines 46, 47 toward the tang 5. The ridge lines 46, 47 are separate from the boundary 9 between the side surfaces 12 of the blade plate 3 and the side surfaces 16 of the tang 5 by the distance S toward the side surfaces 12 of the blade plate 3. The finger rest surfaces 30, 31 incline to gradually separate from the side surfaces 12, 16 of the blade plate 3 and the tang 5 while extending away from the boundary edge portions (the boundary edges 30a, 31a on the ridge lines 46, 47) with respect to the side surfaces 12 of the blade plate 3 toward the tang 5. The distance S is within a range of 10 mm or less, and is preferably set within a range of 0.5 mm or more and 8 mm or less, and more preferably within a range of 1 mm or more and 6 mm or less.

According to a tenth embodiment of the present invention shown in FIGS. 17(a) and 17(b), the edged tool 1 of the first embodiment shown in FIG. 6 (a) is provided with a protective member 48, which is detachably attached to the spine 11. Prior to honing the cutting edge 8 of the edged tool 1 with a hone 49, the protective member 48 is put over the side surfaces 12 of the edged tool 1 to face the hone 49. Therefore, the side surfaces 12 do not contact the hone 49, which prevents the TICN coating from being removed.

In an eleventh embodiment of the present invention shown in FIGS. 18(a) and 18(b), a magnet 51, which absorbs the blade plate 3, is embedded in a case 50, which accommodates the blade plate 3 of the edged tool 1 according to the first embodiment shown in FIG. 6 (a).

The present examples and embodiments are to be considered as illustrative and not restrictive, and the invention is not to be limited to the details given herein, but may be modified within the scope and equivalence of the appended claims.

1. An edged tool with handle comprising a blade including a blade plate and a tang, which extends from the proximal end of the blade plate located opposite to a knife point at the distal end of the blade plate, and a handle having a bolster in which the tang is inserted, wherein the blade includes:
a cutting edge, which extends along the belly of the blade plate from the knife point to a heel located at the proximal end of the blade plate;
a return, which intersects the cutting edge at the heel of the blade plate and is connected to a boundary between the blade plate and the tang located at the proximal end of the blade plate;
a belly edge connected to the return on the belly of the tang to form a step;
a spine that extends along the back of the blade plate from the knife point to the boundary between the blade plate and the tang;
a spine that is connected to the spine of the blade plate on the back of the tang;
an edge of the tang located between the belly edge and the spine;
side surfaces of the blade plate surrounded by the cutting edge, the return, the spine, and the boundary; and
side surfaces of the tang surrounded by the boundary, the belly edge, the spine, and the edge,
wherein finger rest surfaces are formed on side surfaces of the bolster, which side surfaces are adjacent to the side surfaces of the blade plate, the finger rest surfaces extend toward the tang from the boundary between the side surfaces of the blade plate and the side surfaces of the tang or from base lines, which are apart from the boundary toward the side surfaces of the blade plate, and the finger rest surfaces are inclined to gradually separate from the side surfaces of the blade plate and the tang while extending away from boundary edge portions with respect to the side surfaces of the blade plate toward the tang.

2. An edged tool with handle comprising a blade including a blade plate and a tang, which extends from the proximal end of the blade plate located opposite to a knife point at the distal end of the blade plate, and a handle having a bolster in which the tang is inserted, wherein the blade includes:
a cutting edge, which extends along the belly of the blade plate from the knife point to a heel located at the proximal end of the blade plate;
a return, which intersects the cutting edge at the heel of the blade plate and is connected to a boundary between the blade plate and the tang located at the proximal end of the blade plate;
a belly edge connected to the return on the belly of the tang to form a step;
a spine that extends along the back of the blade plate from the knife point to the boundary between the blade plate and the tang;
a spine that is connected to the spine of the blade plate on the back of the tang;
an edge of the tang located between the belly edge and the spine;
side surfaces of the blade plate surrounded by the cutting edge, the return, the spine, and the boundary; and
side surfaces of the tang surrounded by the boundary, the belly edge, the spine, and the edge,
wherein finger rest surfaces are formed on side surfaces of the bolster, which side surfaces are adjacent to the side surfaces of the tang, the finger rest surfaces extend toward the edge of the tang from base lines, which are apart from the boundary between the side surfaces of the blade plate and the side surfaces of the tang toward the side surfaces of the tang by a range of 10 mm or less, and the finger rest surfaces are inclined to gradually separate from the side surfaces of the tang while extending away from boundary edge portions with respect to the side surfaces of the tang toward the edge of the tang.

3. The edged tool with handle according to claim 1, wherein the finger rest surfaces of the bolster are inclined such that both of the finger rest surfaces form concavities, one of the finger rest surfaces forms a concavity while the other one of the finger rest surfaces forms a convexity, or both of the finger rest surfaces form convexities.

4. The edged tool with handle according to claim 2, wherein the finger rest surfaces of the bolster are inclined such that both of the finger rest surfaces form concavities, one of the finger rest surfaces forms a concavity while the other one of the finger rest surfaces forms a convexity, or both of the finger rest surfaces form convexities.

5. The edged tool with handle according to claim 1, wherein the handle includes a grip portion, which extends from the bolster located at the head portion toward the butt portion, and the side surfaces of the bolster are provided with the finger rest surfaces, which are inclined to form concavities, and finger contact surfaces, which are provided between the finger rest surfaces and the grip portion and are continuous with the finger rest surfaces.

6. The edged tool with handle according to claim 2, wherein the handle includes a grip portion, which extends from the bolster located at the head portion toward the butt portion, and the side surfaces of the bolster are provided with the finger rest surfaces, which are inclined to form concavities, and finger contact surfaces, which are provided between the finger rest surfaces and the grip portion and are continuous with the finger rest surfaces.

7. The edged tool with handle according to claim 5, wherein a ridge line is provided on one of side surfaces of the grip portion, which side surfaces are adjacent to the finger contact surfaces of the bolster, the ridge line extends along the longitudinal direction connecting the head portion and the butt portion of the handle, and a ridge line continuous with the ridge line of the side surface of the grip portion is provided on one of the finger contact surfaces of the bolster.

8. The edged tool with handle according to claim 7, wherein the ridge line of the finger contact surface of the bolster includes a first ridge line, which extends along the longitudinal direction of the handle and is continuous with the ridge line of the side surface of the grip portion, and second ridge lines branched from the first ridge line toward the finger rest surfaces of the bolster.

9. The edged tool with handle according to claim 5, wherein, as for the maximum dimensions of the finger rest surfaces of the side surfaces of the bolster along the longitudinal direction of the handle, the maximum dimension of the finger rest surface of one of the side surfaces of the bolster is greater than the maximum dimension of the finger rest surface of the other one of the side surfaces, and as for the minimum dimensions of the finger contact surfaces of the side surfaces of the bolster along the longitudinal direction of the handle, the minimum dimension of the finger contact surface of one of the side surfaces of the bolster is smaller than the minimum dimension of the finger contact surface of the other one of the side surfaces.

10. The edged tool with handle according to claim 1, wherein the finger rest surfaces of the bolster are continuous and flush with the side surfaces of the bolster or the side surfaces of the tang at the boundary edge portions of the finger rest surfaces.

11. The edged tool with handle according to claim 2, wherein the finger rest surfaces of the bolster are continuous and flush with the side surfaces of the bolster or the side surfaces of the tang at the boundary edge portions of the finger rest surfaces.
